(19) United States
(12) Patent Application Publication
(10) Pub. No.: US 2007/0138199 A1
(43) Pub. Date: Jun. 21, 2007

(54) Feed mechanism for a vending machine

(76) Inventors: Jae-Jeong Yang, Yeongdong-Gun (KR); Woo-Suk Yang, Yeongdong-Gun (KR); Sung-Ok Kang, Daejeon (KR)

Correspondence Address: IPLA P.A., 3580 WILSHIRE BLVD., 17TH FLOOR, LOS ANGELES, CA, 90010, US

(21) Appl. No.: 10/598,674

(22) PCT Filed: Mar. 9, 2005
(86) PCT No.: PCT/KR05/00640

§ 371 Date: Sep. 7, 2006

(30) Foreign Application Priority Data
Mar. 9, 2004 (KR) 20 2004 0006314
Mar. 9, 2004 (KR) 20 2004 0006301
Mar. 9, 2004 (KR) 20-2004-0006294

(51) Int. Cl. G07F 11/00

(52) U.S. Cl. 221/125

(57) ABSTRACT

Disclosed a feed mechanism for a vending machine capable of receiving transporting and discharging various products regardless of a change in size such as a length, a diameter etc. of the product. The feed mechanism includes a cabinet having a space receiving the products; a driving unit mounted on an upper portion of the cabinet; a transporting unit driven by the driving unit and having a plurality of pockets for receiving the products; and a discharging unit discharging the products transported by the transporting unit.

### TECHNICAL FIELD

The present invention relates to a vending machine, and more particularly to a feed mechanism for a vending machine capable of receiving, transporting and discharging a product regardless of a change in size such as a length, a diameter etc. of the product.

### BACKGROUND ART

Such a feed mechanism has various structures, for example, of helically advancing a selected product from storage within the cabinet of the vending machine to a discharge chute accessible to the consumer. In this case, due to helical advancement, when the products have a long length, the cabinet should have a big volume. These long products are stacked within the cabinet in one or two rows, each of which is discharged, for example, by its self-weight.

In this manner, the products available for the vending machine are restricted to a size such as a length, a diameter etc. The typical beverage product is formed of a metal container, a plastic container, or a glass container. Among them, one formed of the metal container has more uniform length and diameter than those formed of the plastic and glass containers. For this reason, the products formed of the metal container have been used for the vending machine. By contrast, the products formed of the plastic and glass containers have not been used well for the vending machine due to their various sizes. This various sizes of the products formed of the plastic and glass containers are responsible for restriction to the use for the vending machine.

### DESCRIPTION OF THE DRAWINGS

The above and other objectives, features and other advantages of the present invention will be more clearly understood from the following detailed description taken in conjunction with the accompanying drawings, in which:

FIG. 1 is a perspective view showing a feed mechanism for a vending machine according to the present invention;

FIG. 2 is a side cross-sectional view showing a feed mechanism for a vending machine according to the present invention;

FIG. 3 is a top view showing a feed mechanism for a vending machine according to the present invention;

FIGS. 4 and 5 are a side view and front view showing a transporting unit employed to a feed mechanism for a vending machine according to the present invention, respectively;

FIG. 6 is a side view showing a discharging unit employed to a feed mechanism for a vending machine according to the present invention;

FIG. 7 is a front view showing a discharging unit employed to a feed mechanism for a vending machine according to the present invention;

FIGS. 8 and 9 are side views showing a sensing unit employed to a feed mechanism for a vending machine according to the present invention, wherein FIG. 8 shows a state where the sensing unit comes into contact with a product, and FIG. 9 shows a state where the sensing unit is released from a product; and

FIG. 10 shows a control circuit for controlling an operation of a feed mechanism for a vending machine according to the present invention.

### DISCLOSURE

[Technical Problem]

Therefore, the present invention has been made in view of the above problems, and it is an objective of the present invention to provide a feed mechanism for a vending machine capable of making use of beverage products of various sizes.

[Technical Solution]

In accordance with an aspect of the present invention, the above and other objectives can be accomplished by the provision of a feed mechanism for a vending machine capable of actively coping with a change in size of products. The feed mechanism comprises: a cabinet; a driving unit mounted on an upper portion of the cabinet; a transporting unit driven by the driving unit and having a plurality of pockets for receiving the products; and a discharging unit discharging the products transported by the transporting unit.

Here, the feed mechanism may further comprise a sensing unit for sensing a position of each of the products.

The transporting unit may include an endless belt having both ends connected to each other, and a plurality of pockets disposed on the endless belt at a predetermined interval.

Further, the endless belt and each of the pockets may be formed of a soft material.

All of the pockets may include a strip subjected to any one of coating and bonding with a silver nano-fiber.

Here, the feed mechanism may further comprise a spacing unit for adjusting a space for receiving the products according to the size of the products

The spacing plate may be composed of two spacing plates, wherein the two spacing plates may be perpendicular to each other.

The discharging unit may be installed on a lower portion of the cabinet at a predetermined angle.

The discharging unit may include a vibration member installed horizontally on a lower portion of the cabinet, and a vibrator vibrating the vibration member.

The discharging unit may include a vibrator installed on a lower portion of the cabinet, wherein the vibrator may include a motor, a gear box coupled with the motor and a vibration member coupled with the gear box.

The vibration member may include at least one coil spring inclined at a predetermined angle.

The sensing unit may include a limit switch fixed on a lower portion of the cabinet, and a linkage cooperating with the limit switch.

The driving unit may include a motor, a driving shaft coupled with the motor, and a driven shaft cooperating with the driving shaft.

There may be installed a driving unit holder between the motor and the driving shaft to rotatably support the driving shaft, wherein the driving unit holder may be provided with a reinforced shaft parallel to the driving shaft.

Each of the pockets may include a rest for resting the product, the rest being located in any one of parallel and oblique directions with respect to the driving shaft.

Each of the pockets may include an input opening for inputting the product and an output opening for outputting the product, the output opening having a corner cut off.

[Advantageous Effects]

The feed mechanism for the vending machine allows for the products to be received in, transported and discharged from the pockets regardless of the change of the sizes of the products.

[Best Mode]

Hereinafter, a feed mechanism for a vending machine will be described in detail with reference to the attached drawings.

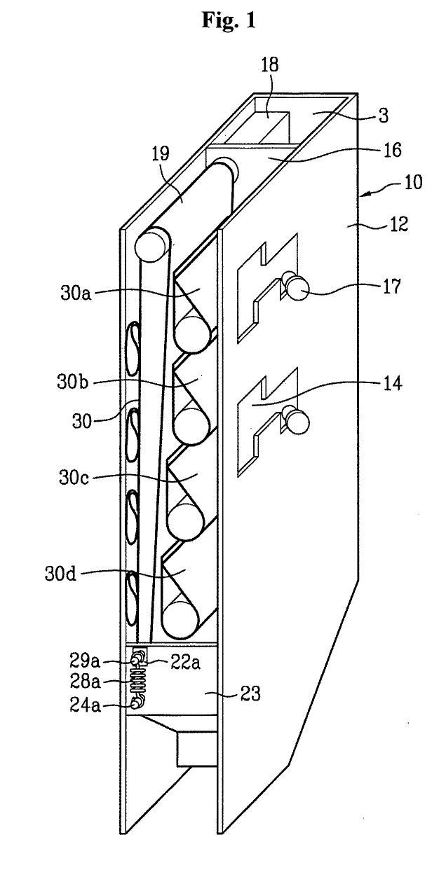

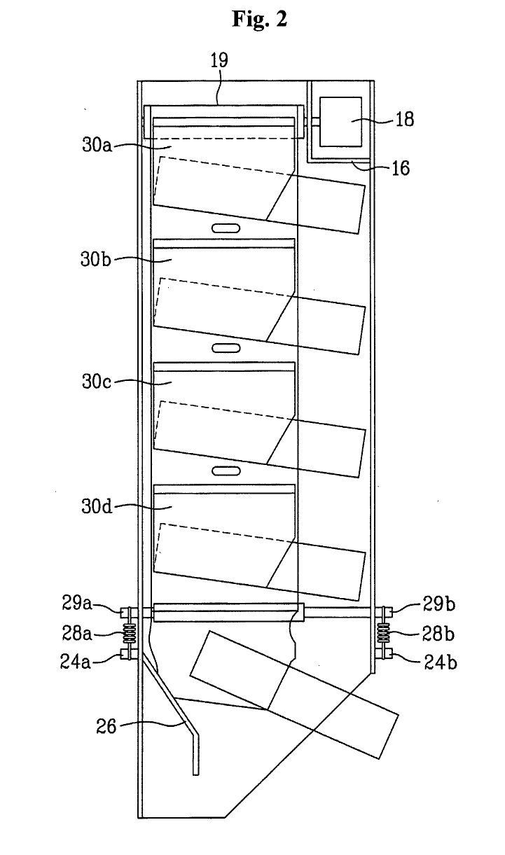

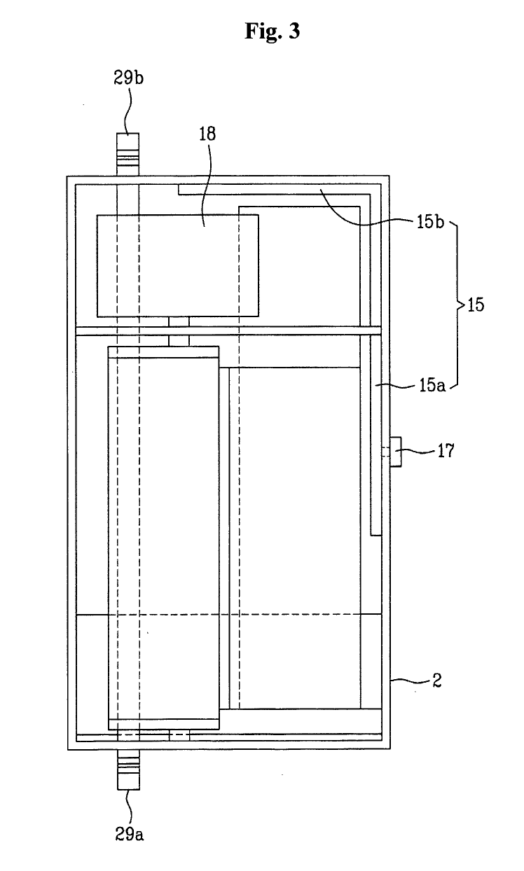

FIGS. 1 and 2 shows the feed mechanism including a cabinet 10 having a rectangular parallelepiped shape, a driving unit installed on an upper portion of the cabinet, a transporting unit 30 driven by the driving unit and having a plurality of pockets for receiving products and a discharging unit discharging the products transported by the transporting unit.

Referring to FIGS. 1 and 2, the cabinet 10 is opened in three directions, i.e., frontward, upward and downward directions and is closed in other three directions, i.e., rearward and both lateral directions. Thus, the cabinet 10 has both lateral walls 12 and a rear wall 13 which are formed of a sheet material. Here, the opened frontward side serves as an input port for receiving the products, and the opened downward side serves as a discharge port for discharging the products.

The upper portion of the cabinet 10 is provided with a driving motor 18 and a driving shaft 19 coupled with the driving motor and serving as a driving roller. In order to firmly support these driving motor and shaft 18 and 19, a driving unit holder 16 formed of a sheet material is installed between the driving motor 18 and the driving shaft 19. Therefore, the driving shaft 19 is located on one side of the driving unit holder 16, and the driving motor 18 is located on the other side of the driving unit holder 16. The driving shaft 19 is designed so that one end thereof is supported on the driving unit holder 16 and the other is not fixed any portion. In other words, the driving shaft 19 has a cantilever structure. However, if necessary, the driving shaft 19 may further include a reinforcing shaft that is provided in parallel under the driving shaft and capable of reinforcing a stiffness of the driving shaft. This is because the driving shaft 19 is possible to be bent due to its cantilever structure when it is used for a long time. Further, an outer circumferential surface of the driving shaft 19 is rolled by the transporting unit 30 that will be described below, particularly, an endless belt of the transporting unit 30. At this time, in order to prevent a skid caused by shortage of a frictional force between the outer circumferential surface of the driving shaft 19 and an inner circumferential surface of the endless belt of the transporting unit 30, the outer circumferential surface of the driving shaft 19 is provided with a soft covering layer that is covered with a soft material such as a rubber. The transporting unit 30 will be described below in detail.

A lower portion of the cabinet 10 is provided with a driven shaft 29 that is located in parallel to the driving shaft 19 and serves as a driven roller. An outer circumferential surface of the driven shaft 29 is also provided with a soft covering layer that is covered with the soft material such as the rubber like the outer circumferential surface of the driving shaft 19. In order to install the driven shaft 29, the lower portion of the cabinet 10, particularly, front ends of the both lateral walls 12 are provided with a driven shaft holder 23 formed of a sheet material.

The driven shaft holder 23 is provided with a front through-slot 22a through which one end 29a of the driven shaft 29 passes, and a front nose 24a spaced downwardly apart from the front through-slot 22a by a predetermined distance. A front tension spring 28a is hooked between the one end 29a of the driven shaft protruding through the front through-slot 22a and the front nose 24a. Similarly, the rear wall 13 that is horizontally opposite to the driven shaft holder 23 is provided with a rear through-slot 22b through which the other end 29b of the driven shaft 29 passes, and a rear nose 24b spaced downwardly apart from the rear through-slot 22b by a predetermined distance. A rear tension spring 28b is hooked between the other end 29b of the driven shaft protruding through the rear through-slot 22b and the rear nose 24b. These front and rear through-slots 22a and 22b is preferably formed in an oval shape such that the both ends 29a and 29b of the driven shaft 29 can be displaced up and down. In this manner, the front and rear springs 28a and 28b installed on both ends 29a and 29b of the driven shaft 29 serve as a tension adjustor for adjusting a tension of the transport unit 30 rolled around the driven shaft 29.

Any one of the both lateral walls 12 of the cabinet 10 is formed with at least two spacing slots 14. Further, the spacing slots 14 are vertically spaced apart from each other. Each of the spacing slots 14 takes a wave form and has the same pitch. Therefore, each of the spacing slots 14 has at least two crests and roots. Grasping pins 17 are located in the roots of the spacing slots 14, respectively. The grasping pins 17 are fixed to a spacing plate 15.

The spacing plate 15 takes an “L” shape. To be more specific, the spacing plate 15 consists of a rear spacing plate 15b located on the rear wall 13 of the cabinet 10 and a lateral spacing plate 15a located on any one of the lateral walls 12 of the cabinet 10. These rear and lateral spacing plates 15b and 15a are coupled perpendicular to each other. To this end, a sheet having a predetermined size is folded to 90 degrees, or two sheets having a predetermined size are welded to 90 degrees. The grasping pins 17 are fixed to the lateral spacing plate 15a. For the purpose of displacing the spacing plate 15, an operator displaces the grasping pins 17 from the roots of the spacing slots 14 in a frontward or rearward direction. For example, when the product is short in length, the grasping pins 17 are displaced in the frontward direction. To the contrary, when the product is long in length, the grasping pins 17 are displaced in the rearward direction. Consequently, the spacing plate 15 allows various sizes of products to be received in the cabinet 10. In this manner, both the spacing plate 15 and the grasping pins 17 that are fixed to the spacing plate 15 and are selectively displaced along the spacing slots 14 serve as a spacing unit.

Now, the transporting unit 30 disposed between the driving shaft 19 and the driven shaft 29 will be described.

Referring to FIGS. 2, 4 and 5, the transporting unit 30 includes an endless belt 31 and a plurality of pockets 30a, 30b . . . 30z coupled to the endless belt 31 at a constant interval. Here, the endless belt 31 is prepared by cutting a flexible thin film formed of a plastic material, e.g. PET (polyethylene terephthalate) at predetermined width and length, and bonding two opposite ends of the cut film. Further, each of the pockets 30a, 30b . . . 30z is made in the same fashion as the endless belt 31by by cutting a flexible thin film formed of a plastic material, e.g. PET (polyethylene terephthalate) at predetermined width and length, and bonding two opposite ends of the cut film. Here, for the endless belt 31 and the respective pockets 30a, 30b . . . 30z, there is a resemblance in that their opposite ends are bonded, but there is a difference in that their sizes are different from each other.

In this manner, the opposite ends of the endless belt 31 are connected by using an adhesive, sewing, a heat or their combination. Further, the opposite ends of each of the pockets are connected similar to those of the endless belt 31. At this time, the opposite ends of the endless belt 31 are preferably connected by using the adhesive. Preferably, the opposite ends of each of the pockets are connected by using the sewing. In this case, the opposite ends of each of the pockets 30a, 30b . . . 30z are connected in advance, and then fixed to the endless belt 31. Alternatively, the opposite ends of each of the pockets 30a,30b . . . 30z may be simultaneously fixed to the endless belt 31 by using the sewing.

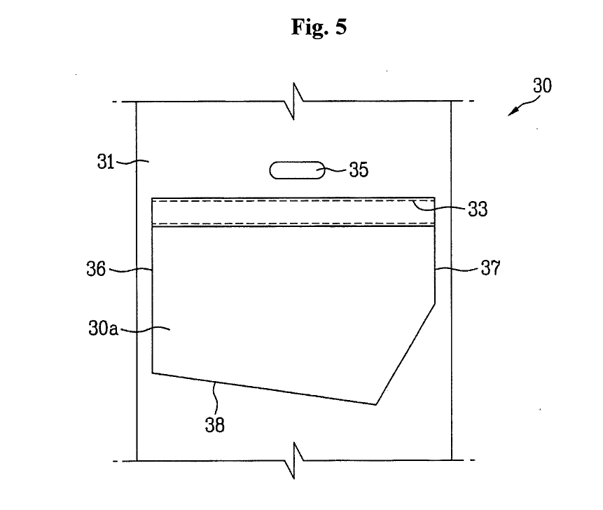

Any one 30a of the pockets will be described in detail with reference to FIG. 5. At least one sewing line 33 is formed between the pocket 30a and the endless belt 31. In this manner, the pocket 30a fixed to the endless belt 31 by sewing take a cylindrical shape. Here, one end of the pocket 30a serves as an input opening 36 for inputting the product, and the other serves as an output opening 37 for outputting the product. When looking at the pocket 30a in front, a part opposite to the sewing line 33 serves as a rest 38 in which the product is rested.

The rest 38 may be implemented into two examples. Among them, one is the case where the rest 38 is obliquely located with respect to the driving and driven shafts 19 and 29 (see FIG. 5), and the other is the case where the rest 38 is located parallel to the driving and driven shafts 19 and 29, that is, perpendicular to a transporting path of the endless belt 31.

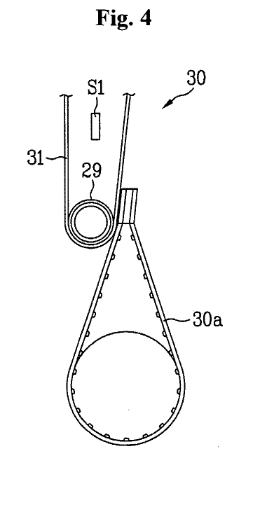

According to the first example of the rest 38, the product is obliquely rested in the rest 38. However, according to the second example of the rest 38, the product is horizontally rested in the rest 38. Therefore, compared with that of the second example, the rest 38 of the first example can easier output the product, and can receive the longer product. Even when the product rested in the rest 38 of the first example is on the slant, the product does not escape during the transportation because it comes into contact with the spacing plate 15. In addition, in order to discharge the product from the pocket in a still easier manner, a part of the pocket, or a corner where the rest 38 encounters with the output opening 37 may be cut off. Preferably, each of the pockets 30a, 30b . . . 30z has an embossed inner circumferential surface (see FIG. 4). This embossed inner circumferential surface of the pocket 30a serves to reduce a contact with the outer circumferential surface of the product. For instance, when the inner circumferential surface of the pocket 30a is smooth and furthermore when at least one of the smooth circumferential surface of the pocket 30a and the outer circumferential surface of the product is covered with minute droplets of water, that is, holds moisture, the two surfaces come into a close contact with each other, thereby generating a vacuum. Consequently, the embossed inner circumferential surface of the pocket 30a prevents the vacuum from being generated. In addition, the embossed inner circumferential surface of the pocket 30a serves to reduce a friction against the outer circumferential surface of the product, so that the product can be easily outputted from the pocket 30a.

Here, the endless belt 31 and the pockets constituting the transporting unit 30 may makes use of any material as long as they can exert a flexible characteristic. Particularly, each of the pockets 30a,30b . . . 30z is partially stacked with at least one strip so as to increase durability. This strip may be formed of a material equal to or different from that of the pocket. Especially, in order to suppress propagation of bacteria, the pockets and/or their strips may be coated with or formed of a silver nano-fiber. Preferably, the pockets may be formed of a general material and their strips may be formed of the silver nano-fiber. More preferably, the may be formed of a general material and their strips may be coated with the silver nano-fiber.

Further, the endless belt 31 is formed with a plurality of sensing holes 35. Each of the sensing holes 35 is located between the pockets 30a, 30b . . . 30z. Thus, the number of sensing holes 35 is the same as that of the pockets 30a, 30b . . . 30z. The sensing holes 35 will be described together with a product discharging unit that will be described below. The sensing holes 35 are sensed by a sensor S1. An example of the sensor may be a proximity sensor or a contact sensor. The proximity sensor may be installed at a proper position within the transporting path of the endless belt 31 of the transporting unit. For the sake of convenience of installation, the sensor may be installed near the driving shaft 19.

As set forth above, the outer circumferential surfaces of the driving and driven shafts 19 and 29 are formed with a soft covering layer. Thus, a friction between the outer circumferential surfaces of the two shafts 19 and 29 and the inner circumferential surface of the endless belt 31 of the transporting unit 30 is enhanced. As a result, a rotational force of the driving shaft 19 is effectively transmitted to the endless belt 31 of the transporting unit 30.

Hereinafter, the product discharging unit will be described in detail with reference to FIGS. 1, 2, 6 and 7.

An example of the discharging unit is shown in FIGS. 1 and 2. The discharging unit includes a slant plate 26. The slant plate 26 is bent at a predetermined angle. The slant plate 26 has an angle of about 60 degrees with respect to the driven shaft 29. The slant plate 26 is brought into contact with the product transported through the transporting unit 30. This contact forces the product to be inclined toward the rear wall 13. In this manner, the inclined product falls rearward due to its self weight. The product discharging unit shown in FIGS. 1 and 2 is to apply a falling principle according to the self weight.

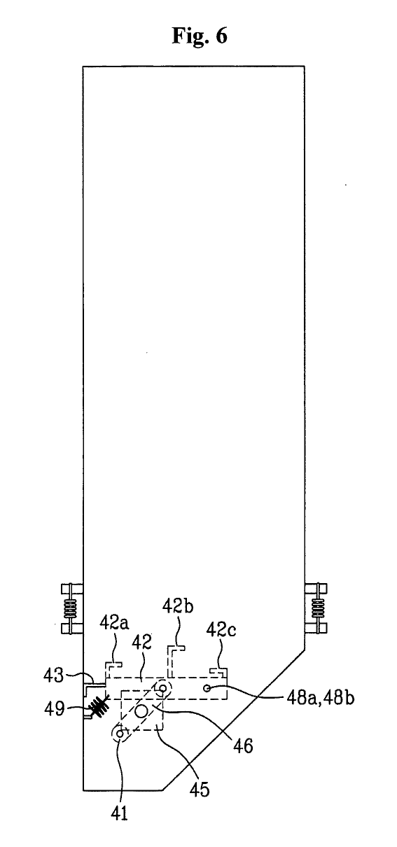

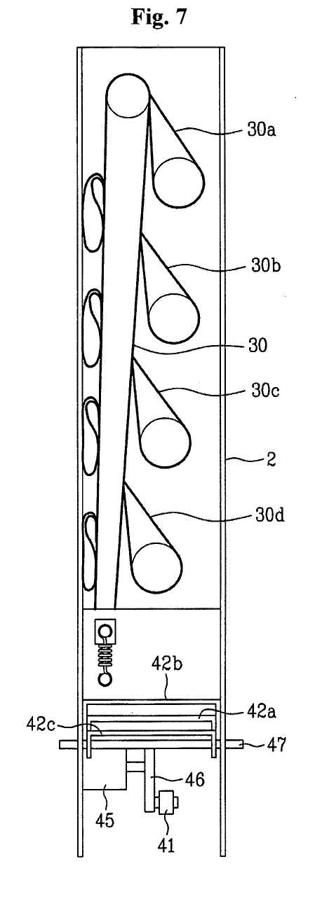

Another example of the discharging unit is shown in FIGS. 6 and 7. Referring to FIGS. 6 and 7, the discharging unit a vibration member 42 mounted pivotably between both lateral walls 12 of the cabinet 10, and a vibrator 45 for vibrating the vibration member 42. The vibration member 42 folds a sheet material to take a “C” shape. Opposite longitudinal flanges of the vibration member 42 are provided with first holes 48a, respectively. The first holes 48a of the vibration member 42 are preferably formed on edges of the vibration member 42 on the side of the rear wall 13. A pivot shaft 47 to be mentioned below is fitted into the first holes 48a. The vibration member 42 can be smoothly pivoted by the pivot shaft 47 fitted into the first holes 48a.

A top surface of the vibration member 42 is provided with at least one protrusion, preferably three protrusions 42a, 42b and 42c that have a different height and are spaced apart from each other by a predetermined distance. Among the three protrusions, the middle protrusion 42b is highest, the rear protrusion 42c located toward the rear wall 13 is lowest. In this manner, to form the protrusions at different heights is for smoothly discharging the products having various lengths. Therefore, the height of each of the protrusions may be changed if necessary.

Further, a front end of the vibration member 42 that is located in front is provided with a tension spring 49. One end of the tension spring 49 is hooked on the front end of the vibration member 42, and the other is hooked on a front wall of the cabinet 10 that extends from the driven shaft holder 23 (FIG. 1). The tension spring 49 helps the vibration member 42 return after the vibration member 42 is elevated by the driving of the vibrator.

The front end of the vibration member 42 neighboring to the tension spring 49 is installed with a stopper 43. The stopper 43 restricts a maximum descent position of the vibration member 42. Thus, the maximum descent position of the vibration member 42 may be maintained parallel to the driven shaft 29 by the stopper 43.

Further, the both lateral walls 12 of the cabinet 10 are formed with second holes 48b, respectively. The second holes 48b correspond to the first holes 48a. When the four holes 48a and 48b are aligned in a row, the pivot shaft 47 is fitted into the holes 48a and 48b.

The vibrator is composed of a typical small electric motor 45 and an arm 46 coupled to a rotational shaft of the motor. The arm may take a disc or rod shape. Both ends of the arm are provided with rollers 41, respectively (in the case of the rode shape). When the motor 45 rotates, the arm 46 rotates. At this time, the rollers 41 provided to the arm 46 are alternately brought into contact with a bottom surface of the vibration member 42. Specifically, the vibration member 42 is gradually ascending and then descending in contact with any one of the rollers 41. The vibration member 42 is vibrated by repetition of the movement. If necessary, a surface of each of the rollers 41 may be formed with a covering layer of a soft material. This covering layer makes it possible to reduce a noise caused by the contact between the rollers 41 and the vibration member 42.

Even if not shown in the drawings, another example of the product discharging unit includes a vibrator. The vibrator is composed of a motor, a gear box coupled to a rotational shaft of the motor, and a vibrating member coupled to the gear box. The vibrating member takes an isosceles trapezoid shape, a “T” shape. Here, a part corresponding to the short base of the isosceles trapezoid is located near the gear box. A part corresponding to the long base of the isosceles trapezoid is located remote from the gear box. Coil springs are hooked between both ends of the short base and both ends of the long base, respectively. At this time, the two coil springs correspond to the sides of the isosceles trapezoid, respectively. The coil springs are located perpendicular to the product transported by the transporting unit 30. Thus, when the motor rotates, a rotational force of the motor is transmitted to the vibration member through the gear box. Thereby, the vibration member rotates. The coil springs of the vibration member provide compatibility with respect to a shape of the product. In other words, when each of the coil springs comes into contact with the product, it is freely bent according to an appearance of the product. Consequently, the coil springs are subjected to the little influence of the shape of the product.

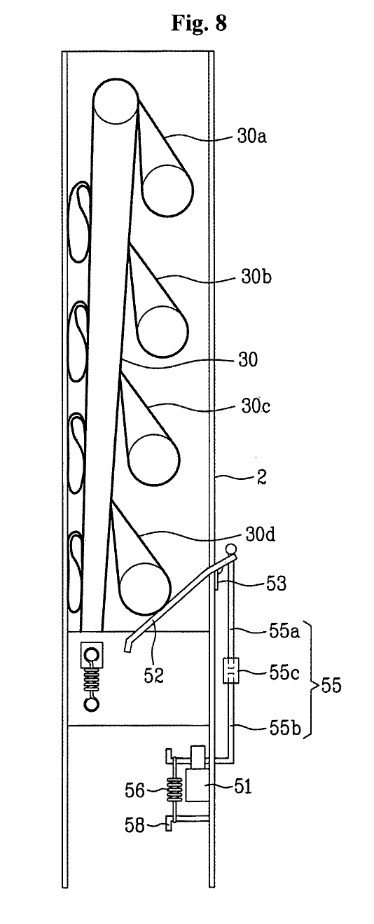

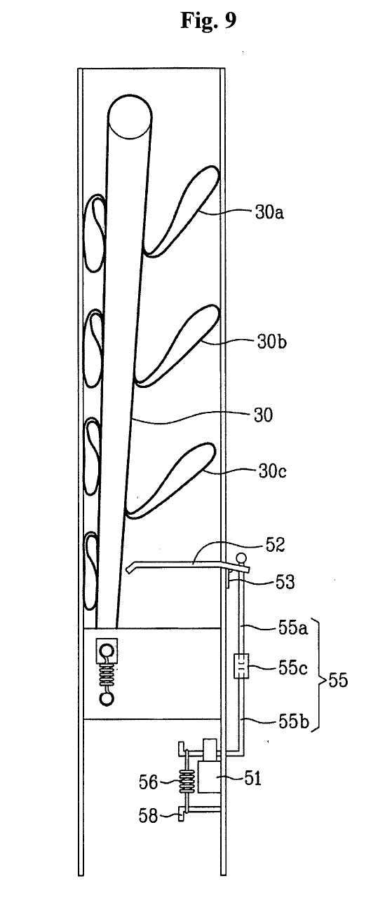

A product sensing unit will be described below with reference to FIGS. 8 and 9.

Referring to FIGS. 8 and 9, the sensing unit includes a limit switch 51 mounted on any one of the lateral walls 12 of the cabinet 10, and a linkage coming into alternate contact with the limit switch and the product.

The limit switch 51 is directly or indirectly mounted on the lateral wall 12 of the cabinet 10 by using screws. When being indirectly mounted, the limit switch 51 is fixed to the lateral wall of the cabinet via a folded piece of an “L” shape. An operation of the limit switch will be described below.

The linkage includes a sensing plate 52 located within a transporting path of the product, and a pitman 55 connected to one end of the sensing plate 52.

The sensing plate 52 has one end drilled with a hole and the other folded at a predetermined angle. A portion (hereinafter, referred to as an “intermediate portion”) near the one end of the sensing plate 52 is folded in a “V” shape. The pitman 55 is loosely connected in the hole formed on the one end of the sensing plate 52, i.e. is connected to be movable up and down. Because the intermediate portion of the sensing plate 52 is folded, it is pivotably seated in an upper slot, so that it is possible to pivot about the upper slot. Alternatively, the intermediate portion of the sensing plate 52 may be fixed via a hinge 53. At this time, any one of two wings of the hinge 53 is fixed to the sensing plate and the other is fixed to the lateral wall 12 of the cabinet 10. Further, the other end of the sensing plate 52 is folded at a predetermined angle. This is for preventing damage of each of the pockets 30a, 30b . . . 30z that receives the product when being released from the product.

The pitman 55 is composed of a first pitman 55a linked to the sensing plate 52, a second pitman 55b connected with a tension spring 56, and a connector 55c connecting the first and second pitmans 55a and 55b. The first pitman 55a takes a linear shape, and the second pitman 55b takes an “L” shape. One end of the second pitman 55b is connected with the connector 55c and the other is connected with the tension spring 56. To this end, the other end of the second pitman 55b is folded at an angle of 90 degrees. Thereby, the tension spring 56 hooked to the other end of the second pitman 55b is prevented from escaping by impact etc. One end of the tension spring 56 is connected to the second pitman 55b and the other is connected to a nose 58 provided on the lateral wall 12 of the cabinet 10. The connector 55c has both ends, each of which is formed with a female thread. Similarly, the first and second pitmans 55a and 55b are each formed with a male thread that corresponds to the female thread of the connector 55c. Thus, the first and second pitmans 55a and 55b can be screwed to the connector 55c. However, it will be understood to those skilled in the art that the connection between the first and second pitmans 55a and 55b and the connector 55c is not limited to this screwing. Further, the second pitman 55b of the “L” shape consists of a horizontal part located on the side of the limit switch 51 and a vertical part located on the side of the lateral wall 12 of the cabinet 10, wherein the horizontal and vertical parts are perpendicular to each other. The horizontal part of the second pitman 55b is provided with a folded part folded in a “V” shape. Therefore, the second pitman 55b can pivot about a lower bore in which the folded part of the horizontal part is located.

Now, an operation of the linkage will be described. Rotation of the transporting unit 30 forces the products to be transported in a clockwise direction. During the transportation, any one of the products comes into contact with the sensing plate 52 at any point of time, wherein the sensing plate 52 is in a sensing standby position (e.g., a position corresponding to about 60 degrees with respect to the lateral wall of the cabinet). The product continues to be in contact with the sensing plate 52 until it goes out of a pivoting radius of the sensing plate 52 (FIG. 8). Then, when the product is released from the sensing plate 52, the sensing plate 52 returns to the sensing standby position (FIG. 9). Here, the fact that the sensing plate 52 returns to the sensing standby position means that no product exists in the pocket. To be more specific, the contact between the product and the sensing plate 52 stops operation of the driving unit driving the transporting unit. When the sensing plate 52 is temporarily released from the preceding product and immediately comes into contact with the following product again, the driving unit is stopped. Consequently, when the sensing plate is located in the sensing standby position in excess of a predetermined time, a word of STOCKOUT is displayed on a display of the vending machine.

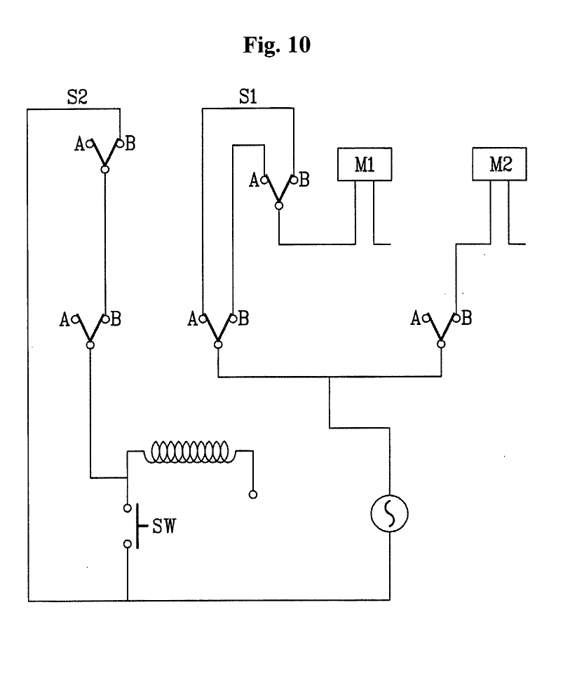

An operation of the feed mechanism as mentioned above will be described with reference to FIG. 10.

Referring to FIG. 10, when a product choice switch of the vending machine is pushed down (On state), a relay maintains the On state as long as it does not trigger S2 and drives a motor M1 of the driving unit and a motor M2 of the discharging unit at the same time. Thus, the transporting unit 30 cooperating with the motor M1 of the driving unit continues to move while the sensing hole 35 is in an S1 position. The sensing hole 35 passes through the S1 position, thereby switching S1 into a B contact (or a normally closed contact). In this case, the motor M1 of the driving unit is not supplied with electric power, so that the transporting unit 30 cooperating with the motor M1 of the driving unit is stopped. However, the relay still maintains the On state. Therefore, the motor M2 of the discharging unit continues to be driven until the product is escaped from any one of the pockets 30a, 30b . . . 30z (the pocket nearest the driven shaft 29) and then triggers S2.

The product is escaped to pass through S2. At this time, a trigger signal is generated to terminate a delay of the relay. Thereby, the relay becomes an A contact (normally opened contact), so that the motor M2 of the discharging unit is no longer supplied with the electric power. However, the motor M1 of the driving unit is supplied with the electric power by means of the A contact of the relay and the B contact of the S1, so that the motor M1 of the driving unit is driven. Then, the transporting unit is transported until the S1 is switched into the A contact.

When the sensing hole 35 encounters with the S1, the SI maintains the A contact. Therefore, this state continues to be kept as long as a sale signal is not triggered.

The above-mentioned operations are summarized in the following Table 1.

| | Contact | Contact | Contact | | | |
|---|---|---|---|---|---|---|
| | of Relay | of S1 | of S2 | M1 | M2 | Remarks |
| Standby State | A | A | B | Stop | Stop | |
| Sale Signal | B | A | B | Running | Running | Choice |
| | | | | | | SW: Set |
| Discharge Section | B | A-B | B | Stop | Running | |
| Transportation | | | | | | |
| Product Response | A | B | B-A-B | Running | Stop | Trigger: |
| | | | | | | Reset |
| Standby Section | A | B-A | B | Stop | Stop | |
| Transportation | | | | | | |

A circuit controlling these operations is designed so that while the products of a preset size are transported, they have a long standby section and a short discharge section in a state where they are safely received in the pockets of the transporting unit. As a result, the product on standby can be rapidly discharged.

Further, the circuit senses whether the desired product is discharged from the pocket of the transporting unit to pass through the discharge port or not. Then, the circuit terminates the operations of the units on the basis of a result of the sensing, so that it is possible to enhance reliability.

In order to simplify the units required for the circuit, the limit switch is designed to be operated through the sensing holes provided within each of the sections. Accordingly, the circuit controls the operations regardless of kinds of electrical sources, so that it is possible to obtain the control circuit simple, inexpensive and reliable.

### INDUSTRIAL APPLICABILITY

As can be seen from the foregoing, according to the feed mechanism for the vending machine, the products can be received in, transported and discharged from the pockets regardless of the change of the sizes of the products. Further, because the transport unit moves from the lower side to the upper side, i.e. in a counterclockwise direction, by means of the driving unit, the products can be subjected to upward discharge. Thus, the feed mechanism can provide various positions where the products are discharged.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A feed mechanism for a vending machine capable of actively coping with a change in size of products, the feed mechanism comprising:
a cabinet;
a driving unit mounted on an upper portion of the cabinet;
a transporting unit driven by the driving unit and having a plurality of pockets for receiving the products ; and
a discharging unit discharging the products transported by the transporting unit.

2. The feed mechanism as set forth in claim 1, further comprising a sensing unit for sensing a position of each of the products.

3. The feed mechanism as set forth in claim 1, wherein the transporting unit includes an endless belt having both ends connected to each other, and a plurality of pockets disposed on the endless belt at a predetermined interval.

4. The feed mechanism as set forth in claim 3, wherein the endless belt and each of the pockets are formed of a soft material.

5. The feed mechanism as set forth in claim 4, wherein all of the pockets includes a strip subjected to any one of coating and bonding with a silver nano-fiber.

6. The feed mechanism as set forth in claim 1, further comprising a spacing unit for adjusting a space for receiving the products according to the size of the products, wherein the spacing unit includes a spacing plate located in the cabinet and grasping pins fixed to the spacing plate and selectively displaced along a spacing slot.

7. The feed mechanism as set forth in claim 6, wherein the spacing plate is composed of two spacing plates, the two spacing plates are perpendicular to each other.

8. The feed mechanism as set forth in claim 1, wherein the discharging unit is installed on a lower portion of the cabinet at a predetermined angle.

9. The feed mechanism as set forth in claim 1, wherein the discharging unit includes a vibration member installed horizontally on a lower portion of the cabinet, and a vibrator vibrating the vibration member.

10. The feed mechanism as set forth in claim 1, wherein the discharging unit includes a vibrator installed on a lower portion of the cabinet, the vibrator including a motor, a gear box coupled with the motor and a vibration member coupled with the gear box.

11. The feed mechanism as set forth in claim 10, wherein the vibration member includes at least one coil spring inclined at a predetermined angle.

12. The feed mechanism as set forth in claim 2, wherein the sensing unit includes a limit switch fixed on a lower portion of the cabinet, and a linkage cooperating with the limit switch.

13. The feed mechanism as set forth in claim 1, wherein the driving unit includes a motor, a driving shaft coupled with the motor, and a driven shaft cooperating with the driving shaft.

14. The feed mechanism as set forth in claim 13, wherein a driving unit holder is installed between the motor and the driving shaft to rotatably support the driving shaft, the driving unit holder being provided with a reinforced shaft parallel to the driving shaft.

15. The feed mechanism as set forth in claim 3, wherein each of the pockets includes a rest for resting the product, the rest being located in any one of parallel and oblique directions with respect to the driving shaft.

16. The feed mechanism as set forth in claim 15, wherein each of the pockets includes an input opening for inputting the product and an output opening for outputting the product, the output opening having a corner cut off.
